(19) United States
(12) Patent Application Publication
(10) Pub. No.: US 2004/0230649 A1
(43) Pub. Date: Nov. 18, 2004

(54) Method for the production of a first identifier isolating a user connecting to a telematics network

(76) Inventor: Jean-Philippe Wary, Bourg La Reine (FR)

Correspondence Address: PERMAN & GREEN, 425 POST ROAD, FAIRFIELD, CT, 06824, US

(21) Appl. No.: 10/668,728

(22) Filed: Sep. 23, 2003

(30) Foreign Application Priority Data
Sep. 24, 2002 (FR) 0211808

(51) Int. Cl. G06F 15/16; H04L 9/00; H04L 9/32

(52) U.S. Cl. 709/203; 709/229; 713/202

(57) ABSTRACT

To protect the privacy of a user subscribing to a mobile telephony operator, the operator produces an isolating identifier by which the user can link up anonymously with a content provider. The operator/producer alone is capable of relating the isolating identifier to the user on request. An isolating identifier is, furthermore, either an isolating session identifier, hence one that changes at each connection of a user to a provider, or an isolating context identifier, hence one that persists over several connections. Furthermore, a context identifier is proper to a user/provider pair. This even further isolates the user.

### BACKGROUND OF THE INVENTION

1. Field of the Invention

An object of the invention is a method for the production of an identifier isolating a user connecting to a telematics network. The field of the invention is that of a user's access to a content provider through a service provider. In particular, the field of the invention is that of the gateways existing between telephone networks and Internet, voice, SMS, MMS type networks, or other carriers for the transmission of multimedia or monomedia contents.

It is an aim of the invention to preserve the user's privacy.

It is another aim of the invention to preserve the customer database of the actors of a network, and to restrict activities of behavior analysis.

It is another aim of the invention to contribute to preserving the secrecy of mail or correspondence.

It is another aim of the invention to enable an authorized legal entity to identify the civil status and identity of a user.

It is another aim of the invention to enable the content provider to manage one or more contexts for users getting connected to said content provider.

2. Brief Description of Related Developments

In the prior art, there are several means by which the content provider can identify a user who accesses one of his services. These means depend on the medium used by the user to access the service. Mainly four modes of access can be distinguished, but the list is not exhaustive. A first mode of access is that of Internet-type access. The Internet access mode can itself be divided into two sub-modes which may be called the connected mode and the unconnected mode. The connected Internet mode is a connection mode using an HTTP (Hyper Text Transfer Protocol) or WTP (Wireless Transfer Protocol) type of protocol. A server, for example a HTTP server, is an apparatus communicating via a network, for example the Internet, according to the HTTP protocol. Such a server hosts Web (Internet) or WAP (Wireless Application Protocol) type networks. There is also an unconnected Internet access mode using an SMTP (Simple Mail Transfer Protocol) type protocol in which the connection actually consists of an exchange of mail-type electronic messages.

Another access mode is a mode of access by operator. This mode itself is also subdivided into two sub-modes. A first access sub-mode, which constitutes a third access mode, is then an access mode that may be called an unconnected mode. This mode uses an SMS (Short Message Service) or MMS (Multimedia Message Service) type protocol. A fourth access mode is a connected mode of access by operator also known as a voice mode in which the accessing user links up with a voice server.

All four access modes have a simple type of solution which consists in making an interface that proposes the keying in of an identifier and a password during a connection to a server. Inasmuch as the user linking up with the server of the content provider does so through a mobile telephone, the means made available to the user in order to key in his identifier (or login username) and password are limited by the user interface of the telephone. Either the identifier and the password are totally numerical, in which case they are difficult to memorize and easy to guess, or the identifier and the password are alphanumerical, in which case it is a tedious task to enter them with a keypad having only nine keys. Furthermore, this keying-in step is an additional step for the user and, in most cases, discourages a mobile telephone user from linking up with a site that offers a connection interface of the type using an identifier and password.

Another approach, in the case of servers of the first type, consists in using a cookie. A cookie is a small file recorded in the user's machine. During a connection to a content provider, this content provider can access this cookie to identify the user. One problem with this approach lies in the fact that it is possible to steal a cookie by electronic or other means. The use of a cookie is therefore not compatible with high security requirements. Another problem then lies in the fact that cookies have a relatively poor reputation. This incites users to erase them. Furthermore, the user may configure the application, or navigator, that he uses to link up with the content provider, so that this application does not accept cookies. In this case, the user is unable to link up with the server of the content provider.

For the third and fourth access modes, the content provider most usually has access to the telephone number of the person calling the server. The content provider is therefore capable of identifying the person through this telephone number. This is bound to raise a problem of protection of privacy. Indeed, it is quite legitimate for the user that he should wish not to be physically identified when he or she links up with the server of the content provider. Indeed, it should be possible to acquire an article anonymously. It is possible, in this situation, to try and link up by masking one's number. However, in this case, it is impossible for the service to be invoiced and hence for the connection to be made effectively. At present, the only solution consists in not linking up with this content provider.

In the description, and in practice, accessing a content provider is equivalent to getting connected to a server of a content provider.

The invention resolves these problems by enabling the production of an identifier that the user presents to the content provider, this identifier allowing no one, other than the person having produced this identifier, to identify the civil status and identity of the user. Such an identifier makes it possible to protect the user's privacy through a request produced by the legal authority seeking to identify the user and comprising the identifier as well as the date on which this identifier was produced.

An isolating identifier according to the invention requires at least two fields in order to be produced. A first field is an identifier of the user. A second field is a field that ensures the variability of the isolating identifier. This variability is ensured either by a pseudo-random piece of data, or by the stated will of the user. The first and second fields are then combined and then transcoded so that the first field is accessible to no one. Only the service provider, namely the entity producing the isolating identifier, is capable of inverting the encryption and therefore identifying the user's civil status and identity. The aims of the invention are therefore truly achieved.

### SUMMARY OF THE INVENTION

An object of the invention therefore is a method for the production of a first context identifier isolating a user getting connected to a content provider through a telematics network and means placed at his disposal by an service provider, the user being identified by means of a second identifier by the service provider, wherein:

the means of the service provider comprise a gateway to associate the first isolating context identifier with the second identifier,

the first isolating context identifier requires, for its production, at least one first field to set up the association between the first isolating context identifier and the user,

the first isolating context identifier requires, for its production, a second field to ensure the variability of the first identifier as a function of the content provider,

the first and second fields are transcoded.

### BRIEF DESCRIPTION OF THE DRAWINGS

The invention shall be understood more clearly from the following description and the accompanying figures. These figures are given purely by way of an indication and in no way restrict the scope of the invention. Of these figures:

FIG. 1 illustrates means useful to the implementation of the method according to the invention;

FIG. 2 illustrates a possible structure for an isolating identifier according to the invention; and

FIG. 3 illustrates steps for the implementation of the method according to the invention.

### DETAILED DESCRIPTION OF THE PREFERRED EMBODIMENT(S)

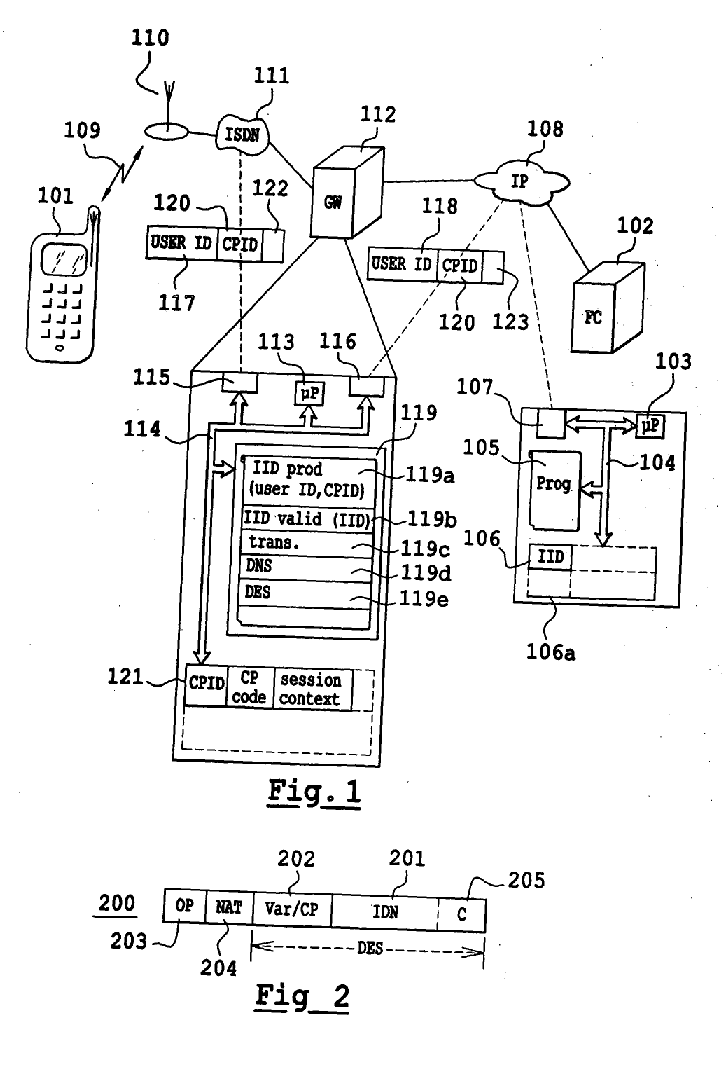

FIG. 1 shows an apparatus 101 used by a user to link up with a server 102 of a content provider. In practice, the apparatus 101 is a mobile telephone capable of setting up a connection according to several protocols. These protocols include Internet-compatible, voice-compatible and SMS-compatible protocols. In other words, the apparatus 101, which is a mobile telephone 101, is capable of setting up communication according to a WAP mode, voice mode and/or SMS mode.

The server 102 is capable of communicating according to at least one of the protocols referred to here above for the telephone 101. The server 102 has a microprocessor 103 connected to a bus 104 internal to the server 102. The bus 104 can be used to connect the microprocessor to a program memory 105, a user memory 106, and interface circuits 107 interfacing for example with the Internet 108.

The memory 105 has instruction codes which control the microprocessor when it performs different actions. In particular, the memory 105 has instruction codes for implementing at least one of the protocols referred to here above.

The memory 106 is, for example, a database. To this end, the memory 106 is described as a table comprising at least as many rows as there are users likely to link up with the server 102, or are already linked up with it. Each row has certain number of fields. A column 106a corresponds to a user identifier field. This is an identifier according to the invention. When the server 102 receives a request, the request comprises this identifier. This enables the server 102 to identify the user and, for example, determine preferences of the user. A set of preferences is also called a context. A context comprises various pieces of information by which the user can customize the appearance and/or the contents of the information presented to him by the server to which he gets connected.

In the example, the memory 106 is included in the server 102. In practice this memory/database 106 may be hosted by another server to which the server 102 can get connected in order to access the contents of said database.

When a user uses the apparatus 101 to get connected to the server 102, the telephone 101 sets up an RF link 109 with the base station 110. The base station 110 is itself connected, through a network 111, for example an ISDN network, to a gateway 112 of a service provider to which, for example, the user of the telephone 101 is a subscriber. The ISDN network 111 is actually all or part of a switched telephone network. In practice, the network 111 may constitute any technical solution whatsoever used to connect a base station to the gateway 112 of the service provider. A service provider is for example a mobile telephony operator.

The content provider is, for example, an access gateway to the Internet, also known as an Internet portal, a weather forecasting voice server or a standard SMS server.

The gateway 112 has a microprocessor 113, connected to a bus 114. This bus 114 also has the following circuits connected to it interface circuits 115 for interfacing with the network 111 and circuits 116 for interfacing with the network 108. The gateway 112 is therefore a gateway between the networks 111 and 108.

On the network 111, the apparatus 101 and therefore its user are identified by a user identifier 117. On the network 108, the user of the apparatus 101 is identified by an isolating identifier 118. One role of the gateway 112 is to set up the link between the identifier 117 and the isolating identifier 118. Another classic role of the gateway 112 is that of carrying out a protocol conversion between the protocols used on the network 111, and the protocols used on the network 108. The identifier 117 is, for example, the phone number of the user of the apparatus 101. Such an identifier 117 is a public identifier that enables everybody to associate a physical person with it. Such a public identifier is, for example, a telephone number, an email address, a public Internet address, etc. One aim of the invention is to prevent the content provider from physically identifying the persons that get connected to the server 102, i.e. to prevent the content provider from identifying their civil status and identity.

The gateway 112 has a program memory. The memory 119 has different zones comprising instruction codes, each corresponding to a task performed by the microprocessor 113.

The zones of the memory 119 include a zone 119a comprising instruction codes corresponding to the production, by the gateway 112, namely in fact by the microprocessor 113, of the isolating identifier 118 from at least the identifier 117 and, in a preferred implementation, the production of a code 120 of the content provider.

The zone 119b has instruction codes enabling the gateway 112 to validate an identifier 118 when the gateway 112 receives a request from the server 102. A zone 119c has instruction codes enabling the gateway 112 to identify a user from an isolating identifier 118. This is used to transmit a response from the server 102 to the apparatus 101 for example. A memory zone 119d has instruction codes used to determine an identifier modifier from an identifier 120 of a content provider. A zone 119e has instruction codes used to perform an encryption operation. Preferably, this is a symmetrical encryption operation.

The gateway 112 has a memory 121 used to associate an identifier of a content provider with a code for this content provider, and with a designation of a nature of an isolating identifier to be produced.

FIG. 2 illustrates a possible structure for an isolating identifier according to the invention. FIG. 2 shows an isolating identifier 200 that requires four fields. Hereinafter in the description, when referring to fields, the verb “to comprise” shall be used to associate fields with an identifier. However, this does not necessarily entail a simple juxtaposition of values. These values may also be combined with one other according to a reversible process by the service provider.

A first field 201 corresponds to the identifier 117 identifying the user of the apparatus 101 on the network 111. The field 201 enables the service provider to identify the civil status and identity of a user. In the case, for example, of a mobile telephony operator, the field 201 comprises the useful digits of a mobile telephony number but also, if necessary, a contract identifier 205 used to link the telephone number to the user. It is possible not to use a contract number but this risks causing confusion if the telephone number is assigned to another user. This contract number is useful when the telephone number is reassigned to another user. Such a contract number is, for example, a counter of the number of assignments of the telephone number. A second field 202 corresponds to a means of obtaining a variation in the isolating identifier 200 as a function either of the user's requirements or of a content provider code. The fields 202 and 201 are combined and/or transcoded through the instruction goals of the zone 119e. The transcoding is preferably a symmetrical encryption. A transcoding may also be made by substitution from a table, or from a sequence of numbers or from a hashing function. Hereinafter in the description, we shall use the example of encryption, but the transcoding may be any type of reversible transcoding. An isolating identifier is then the result of this combining/transcoding operation, i.e. it is a sequence of bits that is unintelligible for any entity other than the service provider. The term “unintelligible” refers to the impossibility of relating the sequence to a civil status and identity.

In one variant, the isolating identifier 200 has a field 203 that makes it possible to identify the service provider that has produced the identifier, and a field 204 making it possible for example to encode a version, and/or nature, for the isolating identifier 200. The isolating identifier 200 is used as an isolating identifier 118 during communications between the gateway 112 and the server 102. It is the isolating identifier 118 that is recorded in the column 106a of the user memory 106 of the server 102. In this variant, an isolating identifier is the juxtaposition of the fields 203, 204 and of the result of the combining/transcoding operation described in the previous paragraph. There is therefore a part that is unintelligible, because it is transcoded by the content provider and a part that is intelligible because it is not transcoded.

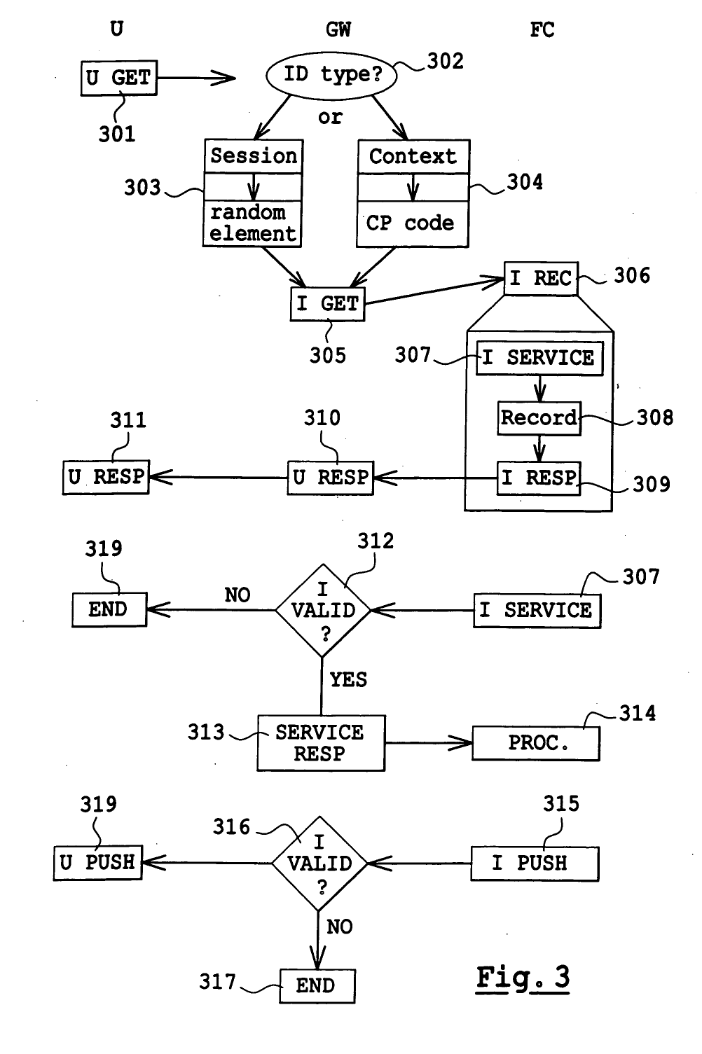

FIG. 3 shows the steps of a scenario in which the method according to the invention is implemented.

FIG. 3 shows a step 301 in which the telephone 101 sends out a request to the content provider 102. This request comprises a user identifier 117, a content provider identifier 120, and a field 122 comprising the request itself. Such a request is, for example, a “Get” request as defined under the HTTP protocol. It must be noted that, since the apparatus 101 is a mobile telephone, it is the WTP protocol that is used. The request produced and sent at the step 301 is received in a step 302 by the gateway 112. In the step 302, the microprocessor 113 extracts the content provider identifier 120 from the request. It then scans the table 121 in search of this content provider identifier. Once it has found the content provider identifier, the microprocessor 113 is capable of determining a code for this content provider as well as an identifier nature. If the identifier of the content provider does not appear in the table 121, the microprocessor 113 adopts a default mode of behavior. In the present example, it is assumed that the default mode of behavior consists in producing an isolating session identifier.

The identifier 120, in a preferred example, is an address in the IPV4 (Internet Protocol Version 4) format. It may also be a telephone number of a voice server or an SMS server. It may also be an Internet address in the IPV6 (Internet Protocol Version 6) format or a URL (Universal Resource Locator), an email address and the like.

If, in the table 121, the content provider identifier 120 corresponds to a nature of an isolating session identifier, the operation passes to a step 303 for the production of an isolating session identifier. If not, it passes to a step 304 for the production of the isolating context identifier.

Whether it is an isolating session identifier or an isolating context identifier, both have the same structure which is the one described for FIG. 2. What differentiates a session identifier from a context identifier is the contents of the field 202. In the case of the session identifier, the field 202 comprises a piece of random data. Such a piece of random data is constituted, for example, by the number of seconds that have elapsed since 00.00 hours on Jan. 1^{st}, 1970. It may also be any number whatsoever generated by a pseudo-random number generator initialized by the time at which the random element was produced. In general, the pseudo-random piece of data is a random number.

In the step 304, the field 202 corresponds to the content provider code read in the memory 121 at the step 302.

The field 204 can be used for example to encode the nature of the identifier. The field 204 therefore has one value when it is an isolating session identifier, and another value when it is an isolating context identifier. When the value of the field 202 is determined, the microprocessor 113 is capable of producing an isolating identifier according to the invention. The microprocessor 113 encrypts the set formed by the field 202 and the field 201. Then the microprocessor 113 associates the result of the encryption with an identifier 203 of the operator managing the gateway 102, and with the nature 204 of the isolating identifier. Thus, the isolating identifier 118 is obtained. It can be seen that the size of the isolating identifier may be different from the size of the identifier 117. It may be recalled that the fields 203 and 204 are optional.

Once the isolating identifier 118 has been produced, the operation passes to a step 305 for the production and sending of a request to the server 102. The request produced in the step 305 comprises an isolating identifier 118, a content provider identifier 120 and a request field 123. In practice, the fields 120 and 123 are identical to the fields 120 and 122. In the present example, the request produced at the step 305 is in the HTTP format. In this example, the field 120 is then a destination IP address. In practice, the request produced in the step 305 by the gateway 112 is in a format (voice, SMS, IP etc) compatible with the server that the user of the telephone 101 is seeking to link up with.

The isolating identifier field 118 is a field in the format described for FIG. 2. The isolating identifier 118 thus comprises a field identifying the operator that has produced the isolating identifier, a field to encode the nature of the isolating identifier depending on whether it is a session identifier or a context identifier, and an encrypted field. The encrypted field, when decrypted, comprises two fields. These two fields correspond to the fields 202 and 201. The content provider is incapable of carrying out decryption and therefore of accessing the fields 201 and 202.

After having sent the request, the operation passes to a step 306 for the reception of the request sent at the step 305 by the server 102. In the step 306, the server 102 therefore has access to the fields 118 and 123. The field 118 enables it to consult the table 106 in search of certain pieces of information on the user who is linking up with the server 102. In practice, if it is an isolating session identifier, there is little likelihood that the table 106 will comprise information on the user. Indeed, since a session identifier varies at each session, the same user will not link up twice with the server 102 using the same isolating session identifier. For this description, the term “session” is understood to mean a period of time limited, for example, to a quarter of an hour. The duration of the session can easily be measured because an isolating session identifier according to the invention comprises a piece of information on the date of creation, or expiry.

A context identifier may have a far greater lifetime, for example six to eighteen months, or even more. The lifetime of a context identifier is managed, for example, by the key used to carry out the encryption which changes at the frequency of the lifetime of a context identifier. The lifetime of a context identifier may also be managed by the contents of the field 202 which change at the frequency of the lifetime of the context identifier. In one variant using the field 204, an isolating context identifier is therefore typed by the field 204 and has a date of creation. A context identifier than has a lifetime duration expressed, for example, in months or years.

The choice of the lifetime duration, and of its mode of management, is up to the entity responsible for the gateway 112. The fact that the lifetime is guaranteed enables a content provider to associate information, also called context, with this isolating identifier.

Among the possible actions at the step 306, the server 102 may produce and send out a service request to the gateway 112 from the identifier 118. This is the step 307. The server may record information in the table 106. This is the step 308. The server may produce and send out a response to the request from the user of the telephone 101. This is the step 309.

When the server 102 produces a response to the request sent at the step 305, it sets up a response frame comprising a field 118 identifying a user, a field 120 comprising an identifier of the server making the response, and a field 123 which then comprises the response to the request. In a step 310, the gateway 112 receives the response to the request sent at the step 301. The gateway 112 then performs a transcoding between the identifiers 118 and 117 to transmit the response from the server 102 to the telephone 101. The operation then passes to a step 311 in which the apparatus 101 receives the response to the request that it has sent in the step 301.

In the step 310, the transcoding of an identifier can be accompanied by a verification of the validity of the identifier. This verification is done, for example, after the encryption of the encrypted part of the isolating identifier 118 and thus after the retrieval of the value of the field 202. The validation then depends on the nature of the identifier. If it is a session identifier, the field 202 corresponds to a date. This date is then compared with the date at which the response was received. If the difference between these two dates is greater than a predefined period, for example a quarter of an hour, then the request is considered to be non-valid and will not be retransmitted to the apparatus 101.

If it is a context identifier, then the contents of the field 202 are compared with the contents of the code field in the table 121 for the row corresponding to the identifier 120. If there is a match, the request is valid; if not the request is rejected.

In the step 307 the server 102 sends out a service request to the server 112. This request comprises a user isolating identifier, a content provider identifier, and a request field. Such a request may relate, for example, to a user identification request, a request for locating a user, or a request for information on the nature of the apparatus used by the user to get connected to the server 102. This list is not exhaustive. At the step 312, the server 112 receives the service request. At the step 312, the gateway 112 starts by verifying the validity of the isolating identifier. This verification is done as described here above. If the identifier is not valid, the operation passes to an end step 319 in which the gateway 112 does not comply with the service request; if not, the operation passes to a step 314 of response to the service request.

In one variant of the invention, for each content provider, the table 121 furthermore comprises a list of services that the content provider can claim. In the step 313, the gateway 112 then verifies that the content provider sending the request is truly entitled to send this request, i.e. that it can claim this service. If this is the case, the gateway 112 produces a response to this service request and transmits the response to the server 102. If not, there is no response to the service request.

In a step 314, the server 102 receives the response to the service request. This response enables a server 102 to update the table 106 or produce the response of the step 309. Indeed, it can be envisaged that the request sent at the step 301 was a request to know the list of restaurants close to the place in which the user is located. In this case, the server 102 needs to know the location of the user. The server 102 therefore sends a location request to the gateway 112. The response to this location enables a server 102 to send the appropriate response to the user of the apparatus 101.

Through an identifier according to the invention, the server 102, in a step 315, can also send a push request to the apparatus 101. This push request is received in a step 316 by the gateway 112. This push request is subjected to verification by the identifier 118. This verification is identical to the verifications described for the steps 310 and 312 and 313. In other words, the content provider identified by the field 120 must be authorized to send out a push request and, furthermore, the identifier 118 should be valid. If the identifier is not valid, the operation passes to an end step 319 in which no positive response whatsoever is given to the push request sent out by the server 102.

If the step 316 reveals that the push request sent at the step 315 is valid, then the gateway 112 transcodes the isolating identifier 118 into an identifier 117 and transmits the transcoded push request to the telephone 101. In a step 317, the telephone 101 receives and processes this push request. Such a push request is, for example, an updating of a database in the apparatus 101. Such a database may relate, for example, to contacts that the user of the apparatus 101 wishes to keep, or a list of servers that the apparatus 101 can link up with in order to access different services.

The encryption algorithm used to encrypt the fields 202 and 201 is preferably the DES (Data Encryption System) or 3DES algorithm. It may be the block encryption version or the chained encryption version of this algorithm. The chained encryption version makes it possible to ensure that all the encrypted parts of the identifier 200 will be different owing to the variable field 202. Variants of the invention may use other encryption algorithms such as the AES (Advanced Encryption System) algorithm.

One advantage of the invention and of the isolating context identifiers defined by it is that one user can have a different context identifier for each content provider. It is thus impossible for a content provider to collate his databases with the databases of other content providers so as to obtain more knowledge about the private life of users identified by the identifier. It is also impossible for a content provider to raid a database of a service provider because the content provider has no certainty on the civil status and identity of the user or on the fact that the same user always makes connection with the same isolating identifier. Thus, maximum protection is obtained for the user's privacy.

The legal requirements are also met since, starting from an identifier and only for the operator who has produced this identifier, it is possible to trace an operation back to the physical user with the cooperation of the service provider.

A user may choose to link up always by using a session identifier. Thus, during two connections that are reasonably spaced out in time, the user who has made this choice will link up with a same site by presenting two different isolating identifiers. The content provider then has no means of determining that it is the same user who has linked up twice.

A user may choose to have recourse to a context identifier. In this case, the gateway 112 will produce an isolating context identifier during connections by the user who has made this choice. The content provider could then adapt its responses according to the information that it is capable of attaching to the isolating context identifier.

The user's choice is managed, on the gateway 112, through a table associating a user identifier, such as the identifier 117, with a choice of user.

The invention is totally transposable if we consider a user using a personal computer to link up with a content provider through an Internet service provider (or ISP). In this case, the connection mode between the personal computer and the gateway is a radiofrequency (GSM, UMTS etc.) mode, a cable (switched telephony network) mode, or other similar mode.

The invention also has the advantage of exempting the entity that manages the isolating identifiers from having to store these isolating identifiers. Indeed, since these identifiers are computed from data that is easily accessible at the time of computation, there is no need to store them.

Finally, an isolating identifier according to the invention is conveyed both in a telephony standard NDS field and in a frame of any protocol used on the Internet. An isolating identifier according to the invention is therefore universal and makes it possible, inter alia, for a user to link up with different types of servers of a same content provider in using the same isolating context identifier. This greatly simplifies the task of the content providers who can unify their context management independently of the type of server.

What is claimed is:

1. A method for the production of a first context identifier isolating a user getting connected to a content provider through a telematics network and means placed at his disposal by an service provider, the user being identified by means of a second identifier by the service provider, wherein:
the means of the service provider comprise a gateway to associate the first isolating context identifier with the second identifier,
the first isolating context identifier requires, for its production, at least one first field to set up the association between the first isolating context identifier and the user,
the first isolating context identifier requires, for its production, a second field to ensure the variability of the first identifier as a function of the content provider,
the first and second fields are transcoded.

2. A method according to claim 1, wherein the first field comprises the second identifier.

3. A method according to claim 1, wherein the contents of the second field depend on a contract existing between the user and the service provider.

4. A method according to claim 1, wherein the lifetime of an isolating context identifier is managed by the contents of the second field which change at a determined frequency which becomes the frequency of the lifetime of the context identifier.

5. A method according to claim 1, wherein the lifetime of a context identifier is managed by the key used to perform the transcoding that changes at a determined frequency which therefore becomes that of the lifetime of the context identifier.

6. A method according to claim 1, wherein the first identifier comprises a third field to contain the nature of the identifier.

7. A method according to claim 1, wherein the first identifier comprises a fourth field to identify the service provider.

8. A method according to claim 6, wherein the third field and/or the fourth field are not encrypted.

9. A method according to claim 1, wherein the first field comprises a contract identifier binding the user to the service provider.

10. A method according to claim 1, wherein the context identifier is universal and wherein a same context identifier enables a user to get connected to different types of servers of a same content provider.

11. A method according to claim 1, wherein the contents of the second field are a piece of pseudo-random data.

12. A method according to claim 11, wherein the piece of pseudo-random data is a date.

13. A method according to claim 11, wherein the random element is constant, for the gateway, during a predetermined period.

14. A method according to claim 1, wherein the method of encryption, to transcode the first and second fields, is a symmetrical block encryption method.

15. A method according to claim 1, wherein the method of encryption, to transcode the first and second fields, is a symmetrical encryption method using block chaining.
